(19) United States
(12) Patent Application Publication
(10) Pub. No.: US 2021/0141538 A1
(43) Pub. Date: May 13, 2021

(54) STORAGE MANAGEMENT APPARATUS, STORAGE MANAGEMENT METHOD, AND STORAGE MANAGEMENT PROGRAM

(71) Applicant: Hitachi, Ltd., Tokyo (JP)

(72) Inventors: Hideyuki SAKAI, Tokyo (JP); Masaharu UKEDA, Tokyo (JP); Tomoya OHTA, Tokyo (JP); Soichi TAKASHIGE, Tokyo (JP); Shinichi HAYASHI, Tokyo (JP)

(21) Appl. No.: 17/012,423

(22) Filed: Sep. 4, 2020

(30) Foreign Application Priority Data
Nov. 12, 2019 (JP) 2019-204778

(51) Int. Cl. G06F 3/06

(52) U.S. Cl. CPC G06F 3/0613; G06F 3/0631; G06F 3/0635; G06F 3/0683; G06F 3/0659; G06F 3/067; G06F 3/0653

(57) ABSTRACT

Volume deployment is optimized while adopting layering corresponding to IO density is adopted. A storage management apparatus calculates remaining IO density based on an amount of remaining IOPS and an amount of a remaining capacity in IOPS and a capacity that are providable by a node, the remaining IOPS and the remaining capacity being not allocated to any volume, controls the layers of the node based on the remaining IO density, selects a node on which a volume is to be deployed based on the difference between the IO density of a deployment target volume and the remaining IO density of the node, and determines a node having the smallest difference between the IO density of the deployment target volume and the remaining IO density of the node in the selection of the node as a deployment destination of the volume.

### CROSS-REFERENCE TO RELATED APPLICATION

The present application claims priority from Japanese application JP 2019-204778, filed on Nov. 12, 2019, the contents of which is hereby incorporated by reference into this application.

### BACKGROUND

The present invention relates to a storage management apparatus, a storage management method, and a storage management program.

In order to optimize the performance and costs of the storage, storage systems that layer a plurality of storages having different performances appear and extend their market share. Examples of storages having different performances include HDDs (Hard Disk Drives) and SSDs (Solid State Drives). These storages include devices having different performances, and thus a variety of layers can be achieved.

Many companies release cloud services that provide the resources of storages, i.e., the performances and capacities of storages necessary for operating applications. In such services, menus are sometimes prepared in which the performance used for each data volume, i.e., the values of IOPS (Input Output Per Second) and the capacity are specified for making a contact.

The providers that provide such storage services deploy contracted data volumes corresponding to the contract value in the layered storage system, and thus the providers aim the optimized performances and costs of storages.

Japanese Unexamined Patent Application Publication No. 2014-241117 discloses a storage system that is layered corresponding to IOPS. More specifically, in the technique disclosed in Japanese Unexamined Patent Application Publication No. 2014-241117, IOPS in a given range is adapted to a given layer, and a data volume is deployed on the layer corresponding to the value of IOPS in that range.

### SUMMARY

Presently, for the purpose of extensibility and reduction in costs, the use of a software defined storage (in the following, referred to as an SDS) configured of multiple general-purpose servers (in the following, referred to as nodes) becomes popular. In the SDS, in order to effectively utilize the physical resources of the node, layering corresponding to IO density defined by “IOPS/a capacity” is sometimes adopted. Examples of the physical resources of the node include IOPS and a capacity that can be provided by a CPU (Central Processing Unit), a NIC (Network Interface Card), a memory, a HDD, or an SSD, which constitute a node.

However, in the method disclosed in Japanese Unexamined Patent Application Publication No. 2014-241117, in the choice of layering corresponding to IO density, when IO density in a given range is adopted to a given layer, the range of the IO density corresponding to each layer is fixed to an initial value. Therefore, in the method disclosed in Japanese Unexamined Patent Application Publication No. 2014-241117, depending on the situations of deployment of data volume groups, the IOPS or the capacity of the node that configures layers is in excess, and the effective utilization of the physical resources of the node sometimes fails.

The present invention is made in view of the circumstances, and an object of the present invention is to provide a storage management apparatus, a storage management method, and a storage management program that can optimize volume deployment while adopting layering corresponding to IO density.

In order to achieve the object, a storage management apparatus calculates remaining IO density based on an amount of remaining IOPS and an amount of a remaining capacity in IOPS and a capacity that are providable by a node, the remaining IOPS and the remaining capacity being not allocated to any volume, and controls layers of the node based on the remaining IO density.

According to the present invention, volume deployment can be optimized while layering corresponding to IO density is adopted.

### BRIEF DESCRIPTION OF THE DRAWINGS

FIG. 1 is a block diagram showing the configuration of a storage system to which a storage management apparatus according to a first embodiment is applied;

FIG. 2 is a diagram showing an example of a volume deployment method for the storage management apparatus in FIG. 1;

FIG. 3 is a diagram showing an example of a volume deployment method when the range of IO density corresponding to each layer is fixed to an initial value;

FIG. 4 is a diagram showing an example of an update method for the remaining IO density of the storage management apparatus in FIG. 1;

FIG. 5 is a diagram showing another example of an update method for the remaining IO density of the storage management apparatus in FIG. 1;

FIG. 6 is a diagram showing an example of the node management table shown in FIG. 1

FIG. 7 is a diagram showing an example of the volume management table shown in FIG. 1;

FIG. 8 is a flowchart showing the operation of the contract accepting unit shown in FIG. 1;

FIG. 9 is a flowchart showing the operation of the storage monitoring unit shown in FIG. 1;

FIG. 10 is a flowchart showing the operation of the volume deployment computing unit shown in FIG. 1;

FIG. 11 is a block diagram showing the configuration of a storage system to which a storage management apparatus according to a second embodiment is applied;

FIG. 12 is a flowchart showing the operation of the volume deployment computing unit shown in FIG. 11;

FIG. 13 is a block diagram showing the configuration of a storage system to which a storage management apparatus according to a third embodiment is applied;

FIG. 14 is a flowchart showing the operation of the update frequency setting unit shown in FIG. 13;

FIG. 15 is a block diagram showing the configuration of a storage system to which a storage management apparatus according to a fourth embodiment is applied;

FIG. 16 is a diagram showing an example of the resource unit price management table shown in FIG. 15; and

FIG. 17 is a block diagram showing an example of the hardware configuration of the storage management apparatus according to the first embodiment.

### DETAILED DESCRIPTION

Embodiments will be described with reference to the drawings. Note that the embodiments that will be described below will not limit inventions in claims, and all components and the combinations of these components described in the embodiments are not necessarily required for the solutions of the inventions.

FIG. 1 is a block diagram showing the configuration of a storage system to which a storage management apparatus according to a first embodiment is applied.

FIG. 1, the storage system includes a storage management apparatus 1A, a storage apparatus 2, a client terminal 3, and an operation terminal 4. The storage management apparatus 1A is connected to the storage apparatus 2, the client terminal 3, and the operation terminal 4. The storage management apparatus 1A is a server that manages the storage apparatus 2, for example.

The storage apparatus 2 can configure a storage node that provides a physical volume (in the following, sometimes simply referred to as a node). The storage apparatus 2 is an SDS that is layered with a node group having a plurality of different IO densities, for example, and is operated by the operator of a storage service provider.

The client terminal 3 is a PC (Personal Computer), tablet, or smartphone, for example, connected to the Internet, and operated by the client of the storage service.

The operation terminal 4 is a PC, tablet, or smartphone, for example, connected to the Internet, and operated by the operator of the storage service provider.

The storage management apparatus 1A accepts the settings relating to the function of the storage management apparatus 1A through the operation terminal 4 by the operation of the operator of the storage service provider, accepts the contract of a data volume (in the following, referred to as a volume) through the client terminal 3 by the operation of the client of the storage service, and deploys the volume on the optimum node of the storage apparatus 2 corresponding to the contract content of the volume, the resource use state of the node in the storage apparatus 2, and the setting content by the operator.

At this time, the storage management apparatus 1A calculates remaining IO density based on an amount of remaining IOPS and an amount of a remaining capacity in IOPS and a capacity that are providable by a node, the remaining IOPS and the remaining capacity being not allocated to any volume, and controls the layers of the node based on the remaining IO density. The storage management apparatus 1A can select a node on which the volume is to be deployed based on the difference between the IO density of the deployment target volume and the remaining IO density of the node. At this time, the storage management apparatus 1A determines a node having the smallest difference between the IO density of the deployment target volume and the remaining IO density of the node, for example, as the deployment destination of the volume.

In the following, the configuration and operation of the storage management apparatus 1A will be described more in detail.

Note that in the following description, the case is akin as an example in which one volume is newly deployed on one node. However, the case is also applicable in which a volume already deployed on a node is transferred to another node. The case in which a virtual volume is valid such that one volume is deployed across a plurality of nodes is also applicable to the deployment and transfer of data blocks included in a volume.

The storage management apparatus 1A includes a communicating unit 11, a contract accepting unit 12, an operation parameter setting unit 13, a screen creating unit 14, a volume deployment computing unit 15A, a storage control unit 16, a storage monitoring unit 17, and a storage unit 18.

The storage unit 18 stores a node management table 181, a volume management table 182, and an update frequency setting file 183. The storage unit 18 can be configured of an HDD or SSD that stores these tables and setting files, or can be configured of a database that manages these tables.

The node management table 181 manages volumes deployed on a node and the remaining IO density of a node on which volumes are deployed. The volume management table 182 manages the IOPS and capacity of a volume deployed on a node. The update frequency setting file 183 manages the update frequency of the remaining IO density of a node.

The communicating unit 11 is an interface through which the storage management apparatus 1A externally communicates with the storage apparatus 2, the client terminal 3, and the operation terminal 4, and through which internal communication is performed between components that constitute the storage management apparatus 1A. In order to configure the communicating unit 11, an NIC may be used.

The contract accepting unit 12 receives the contract value of a volume that is to be inputted from the client terminal 3 to the storage management apparatus 1A through the communicating unit 11, records the contract value on the contract value on the volume management table 182 of the storage unit 18, and notifies the volume deployment computing unit 15A that the contract of a new volume is received.

The operation parameter setting unit 13 receives data expressing the setting content to be inputted from the operation terminal 4 to the storage management apparatus 1A through the communicating unit 11, and records the data on the update frequency setting file 183 of the storage unit 18.

The screen creating unit 14 outputs an operation screen for a client to the client terminal 3 through the communicating unit 11 corresponding to the access from the client terminal 3 to the storage management apparatus 1A, and outputs an operation screen for an operator to the operation terminal 4 through the communicating unit 11 corresponding to the access from the operation terminal 4 to the storage management apparatus 1A. The client makes a contract for a volume through the displayed operation screen, and the operator sets the function of the storage management apparatus 1A through the displayed operation screen.

At this time, the screen creating unit 14 can create an operation screen to which the update conditions of the remaining IO density of the node can be inputted, and can display the operation screen on the operation terminal 4. The operator can input the update conditions of the remaining IO density of the node on the operation screen, and can transmit the update conditions to the storage management apparatus 1A.

Upon receiving the notification of receiving the contract of the new volume from the contract accepting unit 12, the volume deployment computing unit 15A reads the contract value of that volume from the volume management table 182 of the storage unit 18, reads the resource use situations of the node from the node management table 181, and reads function settings from the update frequency setting file 183. The volume deployment computing unit 15A calculates a node on which the volume is deployed based on the data and settings, updates the node management table 181 and the volume management table 182, and notifies the storage control unit 16 of an instruction that that volume is created on the specified node.

Upon receiving the notification of the instruction of volume deployment from the volume deployment computing unit 15A, the storage control unit 16 deploys the volume on the specified node of the storage apparatus 2 through the communicating unit 11.

The storage monitoring unit 17 monitors the node groups of the storage apparatus 2 and the resource use situations of the volume groups through the communicating unit 11, records the result on the actual value on the volume management table 182 of the storage unit 18, and updates the deployed and remaining amount of the node management table 181.

FIG. 2 is a diagram showing an example of a volume deployment method for the storage management apparatus in FIG. 1.

In FIG. 2, the volume deployment computing unit 15A in FIG. 1 selects a node on which the volume is to be deployed based on the IO density of the deployment target volume and the remaining IO density of the node.

For example, it is supposed that nodes A to C are provided on the storage apparatus 2 in FIG. 1. Here, it is supposed that an initial value A1 of the IO density of the node A is 2.0, an initial value B1 of the IO density of the node B is 1.0, and an initial value C1 of the IO density of the node C is 0.5. Note that in FIG. 2, the horizontal axis corresponds to the capacity, and the vertical axis corresponds to the IOPS, and then the aspect ratio of the quadrilateral on the coordinates corresponds to the IO density.

It is supposed that a remaining IO density A3 of the node A when a deployed volume A2 is present on the node A is 0.23, a remaining IO density B3 of the node B when a deployed volume B2 is present on the node B is 1.7, and a remaining IO density C3 of the node C when a deployed volume C2 is present on the node C is 0.86.

The volume deployment computing unit 15A is supposed to select the deployment destination of new volumes N1 to N3 from the nodes A to C. At this time, the volume deployment computing unit 15A respectively calculates the differences between the IO densities of the new volumes N1 to N3 and the remaining IO densities of the nodes A to C, and respectively determines the nodes A to C having the smallest difference as the deployment destination of the new volumes N1 to N3.

It is supposed that the IO density of the new volume N1 is 0.25, the IO density of the new volume N2 is 0.9, the IO density of the new volume N3 is 1.8, for example. At this time, the volume deployment computing unit 15A determines the deployment destination of the new volume N1 on the node A, determines the deployment destination of the new volume N2 on the node C, and the deployment destination of the new volume N3 on the node B.

Thus, the new volumes N1 to N3 can be deployed on the nodes A to C while the bias of the allocation of the capacity and IOPS of the nodes A to C is suppressed, and the resources of the nodes A to C can be effectively utilized.

FIG. 3 is a diagram showing an example of a volume deployment method when the range of IO density corresponding to each layer is fixed to the initial value.

In FIG. 3, it is supposed that when new volumes N1 to N3 are given, the differences between the IO densities of the new volumes N1 to N3 and the initial values of the IO densities of the nodes A to C are respectively calculated, and the new volumes N1 to N3 are deployed on the nodes A to C having the smallest difference.

At this time, the new volume N1 is deployed on the node C, the new volume N2 is deployed on the node B, and the new volume N3 is deployed on the node A. When the new volume N1 is deployed on the node C, the capacity of the node C is short, and the IOPS of the node C is left. When the new volume N2 is deployed on the node B, the capacity of the node B is short, and the IOPS of the node B is left. When the new volume N3 is deployed on the node A, the IOPS of the node A is short, and the capacity of the node A is left.

As described above, when the new volumes N1 to N3 are deployed on the nodes A to C based on the difference between the IO densities of the new volumes N1 to N3 and the initial values of the IO densities of the nodes A to C, a bias occurs in the manner of allocation of the resources of the nodes A to C (IOPS and a capacity), and one of IOPS and the capacity is greatly left. Therefore, the timing of adding a node is moved up, and the number of nodes is increased.

However, in the method in FIG. 2, the new volume N1 is deployed on the node A, the new volume N2 is deployed on the node C, and the new volume N3 is deployed on the node B. Therefore, even in the case in which the new volume N1 is deployed on the node C, the new volume N2 is deployed on the node C, and the new volume N3 is deployed on the node B, the shortage of the capacity and IOPS of the nodes A to C is avoid, and the necessity to add a node is eliminated.

FIG. 4 is a diagram showing an example of an update method for the remaining IO density of the storage management apparatus in FIG. 1.

In FIG. 4, the volume deployment computing unit 15A in FIG. 1 can update the remaining IO density every time when a volume is added.

It is supposed that the IO density of a deployed volume B4 of the node B is 1.19, and a remaining IO density B5 of the node B is 0.94, for example. It is supposed that a new volume N4 has been deployed on the node B.

At this time, the volume deployment computing unit 15A updates the remaining IO density of the node B. For example, when the new volume N4 is deployed on the node B, a deployed volume B6 is added to the node B, and a remaining IO density B7 of the node B is updated to 0.89.

FIG. 5 is a diagram showing another example of the update method for the remaining IO density of the storage management apparatus in FIG. 1.

In FIG. 5, the volume deployment computing unit 15A in FIG. 1 may update the remaining IO density “every day” or may update the remaining IO density at intervals such that “after the resources of the node are filled at a predetermined ratio.

For example, the volume deployment computing unit 15A is supposed to update the remaining IO density every day. It is supposed that new volumes N5 to N7 are deployed on the node B on a certain day, the IO density of the new volume N5 is 1.19, the IO density of the new volume N6 is 1.15, and the IO density of the new volume N7 is 1.22. At this time, deployed volumes B8 to B10 are added to the node B, and a remaining IO density B11 of the node B is updated to 0.64.

Thus, compared with the method in FIG. 4 in which the remaining IO density is updated every time when a new volume is deployed, calculation costs can be reduced as well as the use efficiency of the node can be improved depending on the tendency of adding volumes.

Note that the update timing of the remaining IO density may be set based on the remaining amount of the IOPS of the nodes and the remaining amount of the capacity, for example, other than every time when a volume is added or after a lapse of the specified time.

FIG. 6 is a diagram showing an example of the node management table shown in FIG. 1.

In FIG. 6, the node management table 181 includes entries, “a node ID”, “an installation date and time”, “an initial value”, “deployed”, “a remaining amount”, “remaining IO density”, and “a volume ID”.

“The node ID” is a character string that uniquely expresses a node configuring the storage apparatus 2 in FIG. 1.

“The installation date and time” is a date and time at which the node is incorporated in the storage apparatus 2. The storage apparatus 2 is configured of a plurality of nodes in the initial state. Nodes are sequentially added in the storage apparatus 2 corresponding to the use situations of the nodes.

“The initial value” is IOPS and a capacity that can be provided by the node in the state in which no volume is deployed on the node. “The node ID” and “the initial value” are additionally written on the node management table 181 every time when a node is added. However, for example, the operator of the storage service may write “the node ID” and “the initial value” by the operation of the operation terminal 4.

“Deployed” is IOPS and a capacity that are allocated on the volume deployed on the node. “Deployed” is the value that “the contract values” of the volume management table 182 are summed for each node or the value that “the actual values” of the volume management table 182 are summed for each node. However, for example, the volume deployment computing unit 15A may update the IOPS and the capacity of “Deployed” to the deployment destination node when calculating volume deployment, or may update the IOPS and the capacity of “Deployed” to a node when the storage monitoring unit 17 monitors the use situations of that node.

“The remaining amount” is remaining IOPS and a remaining capacity in IOPS and a capacity that are providable by a node, the remaining IOPS and the remaining capacity being not allocated to any volume, and can be obtained by the subtraction of “deployed” from “the initial value”.

“The remaining IO density” is IO density that is calculated from the IOPS and capacity of “the remaining amount”. The IOPS of “the remaining amount” is referred to as remaining IOPS, and the capacity of “the remaining amount” is referred to as a remaining capacity. At this time, the remaining IO density can be defined as the remaining IOPS/the remaining capacity. The volume deployment computing unit 15A updates the remaining IO density according to the timing described in the update frequency setting file 183.

“The volume ID” is the list of IDs of all volumes deployed on the nodes, showing the individual volumes. The individual IDs of the volumes on the node management table 181 have the same values as “the volume ID” described in the volume management table 182 in FIG. 7. The volume deployment computing unit 15A updates “the volume ID” of the node management table 181 to the deployment destination node when calculating volume deployment.

FIG. 7 is a diagram showing an example of the volume management table shown in FIG. 1.

In FIG. 7, the volume management table 182 includes entries, “a volume ID”, “a node ID”, “a registration date and time”, “a contract value”, and “an actual value”.

“The volume ID” is a character string that uniquely expresses a volume that the client contracts. The contract accepting unit 12 additionally writes “the volume ID” on the volume management table 182 when accepting the contract of the volume.

“The node ID” is an ID showing the node that is the deployment destination of the volume, and has the same value as “the node ID” described in the node management table 181 in FIG. 6. The volume deployment computing unit 15A additionally writes “the node ID” on the volume management table 182 to the corresponding volume when calculating volume deployment. Before the calculation of volume deployment, “the node ID” is set to “not deployed”.

“The registration date and time” is a date and time when “the volume ID” is registered on the volume management table 182.

“The contract value” is the IOPS and capacity of the contracted volume. The contract accepting unit 12 additionally writes “the contract value” on the volume management table 182 when accepting the contract of the volume.

“The actual value” is the IOPS and capacity of the volume under the actual conditions of use after deployed. For example, the IOPS is set to the maximum value of the volume in use, and the capacity is a value that is predicted use amount after a certain period from the use situations of the volume. In the case in which a storage function, such as the elimination of duplication or compression, is applied to the node, “the actual value” may be a value that reflects a reduction in the capacity or an increase in the IOPS, as the effect or influence of that function. The storage monitoring unit 17 may update “the actual value” to the corresponding volume when monitoring the use situations of the volume.

FIG. 8 is a flowchart showing the operation of the contract accepting unit shown in FIG. 1.

In FIG. 8, the contract accepting unit 12 receives the contract values of IOPS and a capacity as new contract contents of the volume from the client terminal 3 via the communicating unit 11 (S41).

Subsequently, the contract accepting unit 12 creates a volume ID that is a character string uniquely determined to that volume, registers the volume ID on the volume management table 182 stored on the storage unit 18, and also registers the registration date and time and the contract value (S42). The contract accepting unit 12 sets the node ID to “not deployed”, and set the actual value to a blank.

Subsequently, the contract accepting unit 12 notifies the volume deployment computing unit 15A of the volume ID of the volume and a new volume contract (S43).

FIG. 9 is a flowchart showing the operation of the storage monitoring unit shown in FIG. 1.

In FIG. 9, the target items for monitoring the storage are the IOPS and capacity of the volumes deployed on a node group configuring the storage apparatus 2. At this time, the storage monitoring unit 17 monitors the IOPS and capacity of the volumes at the same time.

In monitoring the IOPS, the storage monitoring unit 17 makes the reference to the volume management table 182 stored on the storage unit 18 at certain time intervals, and acquires “the actual value” of the IOPS of the volumes, and measures the values of the IOPS of the volumes in use. The storage monitoring unit 17 compares the measured value with “the actual value” of the corresponding volume. When the measured value is greater than “the actual value”, the process goes to Step S52, whereas when the measured value is “the actual value” or less, the measurement of the value of the IOPS in use is repeated (S51).

Subsequently, in the case in which the measured value in a certain volume is greater than “the actual value”, the storage monitoring unit 17 updates “the actual value” in the row of that volume in the volume management table 182 to the measured value (S52).

Subsequently, on the node management table 181 stored on the storage unit 18, the storage monitoring unit 17 updates IOPS on the “deployed” and the IOPS on “the remaining amount” on the row of the node on which the volume is deployed, corresponding to the update of the actual value on the volume management table 182 (S53).

Subsequently, the storage monitoring unit 17 corrects the IOPS to IOPS that can be implemented as a node (S54). In the SDS, IOPS that can be provided by the node is achieved using a CPU. Therefore, in the case in which the storage function consumes the CPU, the IOPS that can be achieved as the node is changed, and thus the correction of IOPS is necessary.

In the correction of IOPS, in the case in which a storage function, such as the elimination of duplication, is used in the storage apparatus 2, for example, the use amount of the CPU by that function in the nodes is measured. The measured value of the use amount of the CPU is converted into the value of IOPS according to the conversion table created based on experiment, for example. The storage monitoring unit 17 further updates the IOPS on the “deployed” and the IOPS on “the remaining amount” of the node on the node management table 181 based on the value of IOPS thus obtained.

On the other hand, in monitoring the capacity, the storage monitoring unit 17 measures the value of the capacity in use in the volumes at a certain time interval, and records the value of the capacity in a certain period (e.g. one month) (S55).

Subsequently, the storage monitoring unit 17 calculates the prediction value of the use amount of the capacity after a lapse of certain time (e.g. after a lapse of one month) based on a change in the value of the capacity in the recorded certain period (S56). For this prediction, methods including regression analysis, for example, can be used.

Subsequently, in the case in which the prediction value in a certain volume is greater than “the actual value” of that volume on the volume management table 182 stored on the storage unit 18, the storage monitoring unit 17 updates “the actual value” to the prediction value (S57).

Subsequently, on the node management table 181 stored on the storage unit 18, the storage monitoring unit 17 updates the capacity on “deployed” and the capacity on “the remaining amount” on the row of the node on which the volume is deployed, corresponding to the update of the actual value (S58).

The storage monitoring unit 17 repeats the monitoring and the update of the tables described above at certain time intervals in regard to IOPS and the capacity.

FIG. 10 is a flowchart showing the operation of the volume deployment computing unit shown in FIG. 1.

In FIG. 10, the volume deployment computing unit 15A receives the notification that a new volume contract is made and the volume ID of that volume from the contract accepting unit 12 (S61).

Subsequently, the volume deployment computing unit 15A makes reference to the volume management table 182 stored on the storage unit 18, and acquires the IOPS and capacity on “the contract value” described on the row corresponding to the volume ID (S62).

Subsequently, the volume deployment computing unit 15A makes reference to the node management table 181 stored on the storage unit 18, and acquires “the remaining amount” and “the remaining IO density” of all the nodes (S63).

Subsequently, the volume deployment computing unit 15A makes reference to the update frequency setting file 183 stored on the storage unit 18, and acquires “the update frequency of the remaining IO density” and “the last update date and time” (S64). Here, on the update frequency setting file 183, “the update frequency of the remaining IO density” and “the last update date and time” are described. “The update frequency of the remaining IO density” can be set “every time” or “every day”, for example. As shown in FIG. 4, “every time” means that “the remaining IO density” on the node management table 181 is updated every time when a new volume contract is made. As shown in FIG. 5, “every day” means that “the remaining IO density” is updated after a lapse of a certain time interval (e.g. every day) regardless of the presence or absence of a new volume contract. “The update frequency of the remaining IO density” may be set by the operator of the storage service using the operation terminal 4, or a certain value may be set as an initial value. “The last update date and time” is a date and time when “the remaining IO density” is updated.

Subsequently, the volume deployment computing unit 15A determines whether “the update frequency of the remaining IO density” is “every time”, or the specified time interval is passed by the comparison of “the last update date and time” with the present time instant (S65). In the case in which “the update frequency of the remaining IO density” is “every time”, or in the case in which the specified time interval is passed by the comparison of “the last update date and time” with the present time instant, the process goes to Step S66, or not, the process goes to Step S67.

Subsequently, in the case in which the case falls in “the update frequency of the remaining IO density”, the volume deployment computing unit 15A calculates “the remaining IO density” of the nodes from IOPS and the capacity on “the remaining amount”, and updates the remaining IO density (S66).

Subsequently, the volume deployment computing unit 15A searches for a node having “the remaining IO density” closest to the IO density calculated from the contract value of the volume of the new contract and having the IOPS and capacity of the contract value of the volume of the new contract is within “the remaining amount”, and determines that node as the deployment destination of the volume of the new contract (S67).

Subsequently, the volume deployment computing unit 15A transmits a notification that the volume in conformance with the contract value of the volume of the new contract is created on the node that is the deployment destination to the storage control unit 16, updates “deployed”, “the remaining amount”, and “the volume ID” on the row of the node on the node management table 181, and updates “the node ID” on the row of the volume on the volume management table 182 (S68).

Note that on the determination of the deployment destination node of the volume corresponding to “the remaining IO density” in Step S67, other methods may be adopted such that the volume is deployed on a node on which “the remaining IO density” after volume deployment is closest to the IO density calculated from “the initial value” of the node, for example.

When “the update frequency of the remaining IO density” is set to “every time”, calculation costs are increased in association with an increase in the number of nodes. Thus, a certain time interval may be specified to suppress the calculation frequency. Depending on the contract tendency of the volume group, when the update frequency of the remaining IO density is performed at a certain time interval, the use efficiency of the physical resources is possibly improved. Thus, the settings of the update frequency of the remaining IO density may be changed while the actual conditions of use are monitored.

In regard to the number of nodes of the storage apparatus 2, the initial value may be a given number of nodes. However, an operation may be performed in which when “the remaining amount” of a certain node is below a certain ratio, a new node is added, for example. The physical resources of the node to be added are options. However, for example, a node that is the same as the node on which “the remaining amount” is below a certain ratio may be prepared, or a node having the physical resources close to the tendency of the IO density of the latest contract volume group may be prepared.

The storage monitoring unit 17 may not be necessarily used. In the case in which the storage monitoring unit 17 is not used, “deployed” of the nodes has a numerical value that the contract values are added as they are. In the case in which the storage monitoring unit 17 is used, a dynamic change in “deployed” of the nodes and the influence of the storage function can be supported, and thus volume deployment can be further optimized.

FIG. 11 is a block diagram showing the configuration of the storage system to which the storage management apparatus according to a second embodiment is applied.

In FIG. 11, this storage system includes a storage management apparatus 1B instead of the storage management apparatus 1A in FIG. 1. The storage management apparatus 1B includes a volume deployment computing unit 15B instead of the volume deployment computing unit 15A in FIG. 1. In the storage management apparatus 1B, a storage unit 18 stores a deploy frequency setting file 184 in addition to the content in FIG. 1. The deploy frequency setting file 184 manages the frequency of the deployment of a new volume on a storage apparatus 2.

On the deploy frequency setting file 184, “a volume deploy frequency” and “a last deploy date and time” are described. “The volume deploy frequency” is a frequency at which the storage management apparatus 1B deploys a new volume group on the storage apparatus 2, and can be set to “every time” or “every day”, for example. “Every time” means that a new volume is deployed every time when a new contract is made. “Every day” means that new volumes are collectively deployed at a regular time of a day regardless of the number or timing of new volume contracts.

“The volume deploy frequency” may be set by the operator of the storage service using an operation terminal 4, or a certain value may be set as an initial value. In the first embodiment, “the volume deploy frequency” corresponds to the case of “every time”. “The last deploy date and time” is a date and time when a volume group is deployed.

The volume deployment computing unit 15B selects a node on which volume is deployed based on the IO density of the combination of a plurality of new volumes and the remaining IO density of the node. For example, the volume deployment computing unit 15B selects the combination of deployment of volumes based on the difference between the remaining IO density before temporary deployment at each node when the combination of a plurality of volumes is temporarily deployed on the node and the remaining IO density after temporary deployment.

FIG. 12 is a flowchart showing the operation of the volume deployment computing unit shown in FIG. 11.

In FIG. 12, the volume deployment computing unit 15B makes reference to the deploy frequency setting file 184 stored on the storage unit 18 in starting (S80).

Subsequently, the volume deployment computing unit 15B determines whether “the volume deploy frequency” described in the deploy frequency setting file 184 is “every time” (S81). When “the volume deploy frequency” is “every time”, the process goes to Step S61 in FIG. 10, and performs processes similar to the volume deployment computing unit 15A in FIG. 1. When “the volume deploy frequency” is not “every time”, the process goes to Step S82.

Subsequently, the volume deployment computing unit 15B compares “the last deploy date and time” described in the deploy frequency setting file 184 with the present time instant. In the case in which the time interval specified by “the volume deploy frequency” is passed, the process goes to Step S83, or not, the volume deployment computing unit 15B waits, and confirms whether the time interval shown by the deploy frequency is passed at every certain time interval (S82).

Subsequently, the volume deployment computing unit 15B makes reference to a volume management table 182 stored on the storage unit 18, and acquires the IOPS and capacity on the contract value” of all the volumes having their node IDs on “not deployed” (S83).

Subsequently, the volume deployment computing unit 15B performs processes in Steps S84 to S87, and the process goes to Step S88. The processes in Steps S84 to S87 are similar to the processes in Steps S63 to S66 in FIG. 10.

Subsequently, the volume deployment computing unit 15B creates all combinations relating to addition to the volume groups of new contracts, i.e., all the volume groups on “not deployed” acquired in Step S83. For example, it is supposed that volumes to be a target is three volumes, volumes X to Z, all combinations relating to addition are five ways, (X, Y, Z), (X+Y, Z), (X+Z, Y), (X, Y+Z), and (X+Y+Z). Here, the symbol + means the addition of IOPSs and the addition of the capacities at the contract value of the volumes.

To these combinations, procedures below are performed. First, a search is made for the IO density calculated from IOPS and the capacity in the beginning element (here, the first element separated by “,” in parentheses, such as X or X+Y) and for a node at which “the remaining IO density” is the closest and the IOPS and capacity of that element is within “the remaining amount”, and that node is set to a temporary deployment destination of a volume corresponding to that element.

In the following, also to the second element, temporary deployment is similarly repeated to the node group in the state in which the beginning element is temporarily deployed. After all the elements are temporarily deployed, the absolute value of the difference between “the remaining IO density” before temporary deployment and “the remaining IO density” after temporary deployment is calculated for each node only to the node group that is a temporary deployment destination. The value that is the total of all the values calculated above is referred to as the deployment residual of the remaining IO density for the combination. The deployment residual of the remaining IO density is calculated to all the combinations, and the combination having the smallest deployment residual is adopted as confirmed deployment (S88). For example, when the combination, (X+Y, Z), is adopted as confirmed deployment, volume X and volume Y are deployed on a certain node, and volume Z is deployed on another node.

Subsequently, the volume deployment computing unit 15B transmits notification that instructs the creation of a volume group in conformance with the contract value of the volume group of the new contract on the node group that is a deployment destination to the storage control unit 16, updates “deployed”, “the remaining amount”, and “the volume ID” on the row of the node group on the node management table 181, and updates “the node ID” on the row of the volume group on the volume management table 182 (S89).

Note that the foregoing second embodiment is an example in which volumes in a plurality of new contracts are separated in some combinations and the volumes are collectively deployed on the node. However, in regard to the determining method for the deployment destination, a method other than the method described above may be adopted.

FIG. 13 is a block diagram showing the configuration of a storage system to which a storage management apparatus according to a third embodiment is applied.

In FIG. 13, this storage system includes a storage management apparatus 1C instead of the storage management apparatus 1B in FIG. 11. In the storage management apparatus 1C, an update frequency setting unit 19 is added to the storage management apparatus 1B. In the storage management apparatus 1C, a storage unit 18 stores an update frequency setting file 183′ instead of the update frequency setting file 183 in FIG. 11.

In the update frequency setting file 183′, “a review frequency” and “a virtual frequency”, and “a last review date and time” are described in addition to “the update frequency of the remaining IO density” and “the last update date and time”.

“The review frequency” is a frequency at which the value of “the update frequency of the remaining IO density” is changed. “The review frequency” takes a value, such as “every week”, for example, and is set from an operation terminal 4 by the operator of the storage service. “The virtual frequency” is the list of the candidates for the possible values of “the update frequency of the remaining IO density”, taking values, such as “every time, a day, three days, five days, and a week”, for example, and set from the operation terminal 4 by the operator of the storage service. “The last review date and time” is a date and time when the value of “the update frequency of the remaining IO density” is updated.

The update frequency setting unit 19 calculates the use situations of the node and the resources when the deployed volume is virtually re-deployed on a deployable node, and sets the update frequency of the remaining IO density of the node based on the use situations of the node and the resources. For example, the update frequency setting unit 19 makes reference to the update frequency setting file 183′ stored on the storage unit 18, and selects the value of “the update frequency of the remaining IO density” from the value included in “the virtual frequency” based on information on the volume group deployed at that time at time intervals in conformance with the value of “the review frequency” set on the update frequency setting file 183′.

FIG. 14 is a flowchart showing the operation of the update frequency setting unit shown in FIG. 13.

In FIG. 14, the update frequency setting unit 19 makes reference to the update frequency setting file 183′ stored on the storage unit 18 in FIG. 13 in starting (S100).

Subsequently, the update frequency setting unit 19 confirms whether the time interval expressed by the review frequency is passed for every certain time interval (S101). At this time, the update frequency setting unit 19 compares “the last review date and time” described in the update frequency setting file 183′ with the present time instant. In the case in which the time interval specified by “the review frequency” is passed, the process goes to Step S102, or not, the update frequency setting unit 19 waits.

Subsequently, the update frequency setting unit 19 makes reference to a volume management table 182 stored on the storage unit 18, and acquires “the registration date and time” of all volumes deployed on any node at the point in time and IOPS and the capacity on “the contract value” (S102).

Subsequently, the update frequency setting unit 19 makes reference to a node management table 181 stored on the storage unit 18, identifies a node group that has configured the initial state of the storage apparatus 2 based on “the installation date and time”, and acquires the IOPS and capacity on “the initial value” of that node group (S103).

Subsequently, the update frequency setting unit 19 performs the procedures below to all the value other than the value of “the update frequency of the remaining IO density” in the values enumerated on “the virtual frequency” described in the update frequency setting file 183′. First, to the node group in the initial state acquired in Step S103, the volume group acquired in Step S102 is virtually re-deployed in the order of “the registration date and time”, in conformance with the method described in the first embodiment, for example (S104). At this time, virtual re-deployment is advanced while “the remaining IO density” of the node is updated corresponding to “the registration date and time”, which are sequentially passed, in accordance with the value specified as “the virtual frequency”. The node is also virtually added in conformance with the criteria prescribed in advance.

After such re-deployment is completed, the number of nodes and the utilization rate of the physical resources of the node are calculated, and the mean value of the utilization rate of the node in all the nodes (in the following, referred to as a review index) is calculated. In regard to the utilization rate of the node, the utilization rate of IOPS and the utilization rate of the capacity are calculated, for example, and a smaller one is adopted. The number of nodes and the review index are calculated in the deployment state in the present situation, i.e., deployment in conformance with “the update frequency of the remaining IO density” described in the update frequency setting file 183′ (S105). From the description above, the number of nodes and the review index are obtained to all the values enumerated on “the virtual frequency”.

In the number of nodes and the review index, when there is one value in “the virtual frequency” having the smallest number of nodes, that value is selected, whereas when there are multiple values, a value having the greatest review index is selected from these values. The value of “the update frequency of the remaining IO density” described in the update frequency setting file 183′ is updated using the selected value (S106). In the following, the volume deployment computing unit 15B calculates volume deployment in accordance with the updated value.

Note that the review of “the update frequency of the remaining IO density” described in the present embodiment may be performed at given timing from the operation terminal 4 by the operator of the storage service, not based on “the review frequency” in the update frequency setting file 183′.

In the foregoing third embodiment, virtual re-deployment in accordance with “the contract value” is performed. However, recording the revision history of “the actual value” of the volumes allows virtual re-deployment and the review of “the update frequency of the remaining IO density”.

FIG. 15 is a block diagram showing the configuration of a storage system to which a storage management apparatus according to a fourth embodiment is applied.

In FIG. 15, this storage system includes a storage management apparatus 1D instead of the storage management apparatus 1A in FIG. 1. The storage management apparatus 1D includes a volume deployment computing unit 15D instead of the volume deployment computing unit 15A in FIG. 1. In the storage management apparatus 1D, a storage unit 18 stores a resource unit price management table 185 in addition to the content in FIG. 1. The resource unit price management table 185 may merge with a node management table 181.

The volume deployment computing unit 15D selects a node on which a new volume is deployed based on the IO density of the new volume, the remaining IO density of the node and costs necessary when a new volume is deployed on the node. For example, in nodes at which the difference between the IO density of the new volume and the remaining IO density of the node is within a predetermined range, the volume deployment computing unit 15D determines a node having the smallest costs as the deployment destination of the new volume.

FIG. 16 is a diagram showing an example of the resource unit price management table shown in FIG. 15.

In FIG. 16, the resource unit price management table 185 includes entries, “a node ID”, “an IOPS unit price”, and “a capacity unit price”.

“The node ID” is a character string that uniquely expresses a node configuring the storage apparatus 2 in FIG. 15.

“The IOPS unit price” is a monthly amount per IOPS of each node, and “the capacity unit price” is a monthly amount per GB of each node. “The IOPS unit price” and “the capacity unit price” are determined from the physical configuration of each node and the business plan of a service provider. The resource unit price management table 185 is set from an operation terminal 4 by the operator of the storage service. When the unit prices are high, expensive physical resources of high reliability are often used, or sophisticated management frameworks are often arranged.

Depending on the client, the client sometimes desires to deploy volumes on highly reliable nodes even though unit prices are high due to mission critical applications, for example, i.e., even though use prices for services are expensive in the same performance or the same capacity. Conversely, there are some clients who desire to use inexpensive nodes as low as possible.

The volume deployment computing unit 15D determines the node that is the deployment destination of the volume while meeting the needs of such clients. More specifically, in the process in Step S67 in FIG. 10, the volume deployment computing unit 15A in FIG. 1 determines a node having “the remaining IO density” closest to the IO density calculated from the contract value of the new volume as the deployment destination of the volume. However, the volume deployment computing unit 15D also searches for the second-closest node, for example, in addition to the closest node. The volume deployment computing unit 15A acquires the IOPS unit prices and the capacity unit prices for these two nodes from the resource unit price management table 185, and calculates the price of the volume. Between these two calculated prices, the volume deployment computing unit 15A determines the node at a price matching with the needs of the client as the deployment destination of the new volume.

As described above, the storage management apparatus 1D makes reference to the remaining IO density of the node as well as makes reference to costs required when the new volume is deployed on the node for selecting the node that is the deployment destination of the new volume, and thus the resource use efficiency of the node can be improved while the needs of the client are reflected.

FIG. 17 is a block diagram showing an example of the hardware configuration of a storage management apparatus according to the first embodiment.

In FIG. 17, a storage management apparatus 100 includes a processor 101, a communication control device 102, a communication interface 103, a main storage device 104, an auxiliary storage device 105, and an input-output interface 107. The processor 101, the communication control device 102, the communication interface 103, the main storage device 104, the auxiliary storage device 105, and the input-output interface 107 are in connection to each other through an internal bus 106. The main storage device 104 and the auxiliary storage device 105 are accessible from the processor 101.

On the outside of the storage management apparatus 100, an input device 110 and an output device 111 are provided. The input device 110 and the output device 111 are in connection to the internal bus 106 though the input-output interface 107. The input device 110 is a keyboard, a mouse, a touch panel, a card reader, a voice input device, and any other device, for example. The output device 111 is a screen display device (a liquid crystal monitor, an organic EL (Electro Luminescence) display, a graphic card, and any other device), a sound output device (a speaker, and any other device), a printer, and any other device, for example.

The processor 101 is hardware that manages the entire operation control of the storage management apparatus 100. The processor 101 may be a CPU (Central Processing Unit), or may be a GPU (Graphics Processing Unit). The processor 101 may be a single-core processor, or may be a multicore processor. The processor 101 may include a hardware circuit that performs a part or all processes (e.g. FPGA (Field-Programmable Gate Array) or ASIC (Application Specific Integrated Circuit)). The processor 101 may include a neural network.

The main storage device 104 can be configured of a semiconductor memory, including an SRAM or DRAM, for example. The main storage device 104 can store programs being executed by the processor 101, or can be provided with work area in which the processor 101 executes programs.

The auxiliary storage device 105 is a storage device including a large capacity storage capacity, and is a hard disk device or SSD (Solid State Drive), for example. The auxiliary storage device 105 can hold the execution files of various programs and data used for executing the programs. On the auxiliary storage device 105, a storage management program 105A and a management information 105B can be stored. The storage management program 105A may be software installable in the storage management apparatus 100, or may be incorporated as firmware in the storage management apparatus 100. The management information 105B is the node management table 181, the volume management table 182, and the update frequency setting file 183 in FIG. 1, for example.

The communication control device 102 is hardware including functions of controlling external communication. The communication control device 102 is connected to the network 109 though the communication interface 103. The network 109 may be a WAN (Wide Area Network), such as the Internet, may be a LAN (Local Area Network), such as WiFi or Ethernet (registered trademark), may be a SAN (Storage Area Network), or a WAN, a LAN, and a SAN may coexist.

The input-output interface 107 converts data inputted from the input device 110 into a data format that can be processed by the processor 101, or converts data outputted from the processor 101 into a data format that can be processed by the output device 111.

The processor 101 reads the storage management program 105A to the main storage device 104, and executes the storage management program 105A. Thus, the layers of the node can be controlled based on the remaining IO density, the node on which the volume is to be deployed can be selected based on the difference between the IO density of the deployment target volume and the remaining IO density of the node, and the node having the smallest difference between the IO density of the deployment target volume and the remaining IO density of the node can be determined as the deployment destination of the volume.

At this time, the processor 101 executes the storage management program 105A, and thus the functions of the communicating unit 11, the contract accepting unit 12, the operation parameter setting unit 13, the screen creating unit 14, the volume deployment computing unit 15A, the storage control unit 16, and the storage monitoring unit 17 in FIG. 1 can be implemented.

Note that the execution of the storage management program 105A may be shared by a plurality of processors or computers. Alternatively, the processor 101 may instruct a cloud computer, for example, to the execution of all or a part of the storage management program 105A through the network 109, and may receive the execution result.

Note that the present invention is not limited to the forgoing embodiments, and includes various exemplary modifications. For example, the forgoing embodiments are described in detail for easy explanation of the present invention, and is not necessarily limited to ones having all the configurations described above. A part of the configuration of an embodiment can be replaced by the configuration of another embodiment, and the configuration of another embodiment can also be added to the configuration of an embodiment. In regard to a part of the configurations of the embodiments, another configuration can be added, removed, or replaced. A part or all the configurations, functions, processing units, processing units, and any other components may be implemented by hardware, by designing using integrated circuits, for example.

What is claimed is:

1. A storage management apparatus comprising:
calculating remaining IO density based on an amount of remaining IOPS (Input Output Per Second) and an amount of a remaining capacity in IOPS and a capacity that are providable by a node, the remaining IOPS and the remaining capacity being not allocated to any volume; and
controlling layers of the node based on the remaining IO density.

2. The storage management apparatus according to claim 1,
wherein a node on which the volume is to be deployed is selected based on IO density of a deployment target volume and remaining IO density of the node.

3. The storage management apparatus according to claim 2,
wherein a node having a smallest difference between the IO density of the deployment target volume and the remaining IO density of the node is determined as a deployment destination of the volume.

4. The storage management apparatus according to claim 1,
wherein a node on which the volume is to be deployed is selected based on IO density of a deployment target volume, remaining IO density of the node, and a cost necessary when the volume is deployed on the node.

5. The storage management apparatus according to claim 4,
wherein in nodes having a difference between the IO density of the deployment target volume and the remaining IO density of the node is within a predetermined range, a node having the cost that is smallest is determined as a deployment destination of the volume.

6. The storage management apparatus according to claim 2,
wherein remaining IO density of the node is updated every time when a request for deployment of the volume is made.

7. The storage management apparatus according to claim 2,
wherein the remaining IO density of the node is updated every time when a specified time is passed.

8. The storage management apparatus according to claim 2,
wherein: an update condition of remaining IO density of the node is created on an inputtable screen; and
the remaining IO density of the node is updated based on an inputted update condition on the screen.

9. The storage management apparatus according to claim 2,
wherein a node on which the volume is to be deployed is selected based on IO density that is a combination of a plurality of the deployment target volumes and the remaining IO density of the node.

10. The storage management apparatus according to claim 9,
wherein a combination of deployment of the volumes is selected based on a difference between remaining IO density before temporary deployment of each of the nodes when the combination of the plurality of the deployment target volumes is temporarily deployed on the node and remaining IO density after temporary deployment.

11. The storage management apparatus according to claim 2,
wherein use situations of a node and a resource when a deployed volume is virtually re-deployed on the node on which the volume is deployable are calculated; and
an update frequency of the remaining IO density of the node is set based on the node and the use situation of the resource.

12. A storage management method comprising:
calculating remaining IO density based on an amount of remaining IOPS and an amount of a remaining capacity in IOPS and a capacity that are providable by a node, the remaining IOPS and the remaining capacity being not allocated to any volume; and
controlling layers of the node based on the remaining IO density.

13. A storage management program that allows a computer to execute the steps of:
calculating remaining IO density based on an amount of remaining IOPS and an amount of a remaining capacity in IOPS and a capacity that are providable by a node, the remaining IOPS and the remaining capacity being not allocated to any volume; and
controlling layers of the node based on the remaining IO density.
